(19) United States
(12) Patent Application Publication
(10) Pub. No.: US 2007/0283894 A1
(43) Pub. Date: Dec. 13, 2007

(54) BIRD FEEDER BASE WITH INTEGRALLY FORMED AND THREADED ACCESSORY MOUNT

(75) Inventor: Robert E. Bescherer, Bristol, RI (US)

Correspondence Address: BARLOW, JOSEPHS & HOLMES, LTD., 101 DYER STREET, 5TH FLOOR, PROVIDENCE, RI, 02903, US

(73) Assignee: ASPECTS, INC., Warren, RI (US)

(21) Appl. No.: 11/761,429

(22) Filed: Jun. 12, 2007

Related U.S. Application Data
(60) Provisional application No. 60/804,511, filed on Jun. 12, 2006.

(51) Int. Cl. A01K 39/01

(52) U.S. Cl. 119/57.8

(57) ABSTRACT

The present invention is generally directed to a novel and unique bird feeder base that includes a main body having a bottom edge where the bottom edge defines a bore having an inner surface. The inner surface of the bore has at least one female thread member residing and extending less than 360 degrees about such inner surface. Most importantly, the female thread member can be formed without the need for time consuming drilling and tapping. In addition, the bore and female thread member on the inner surface thereof is threadably engagable with a male threaded accessory, such as a mounting post, seed tray or squirrel guard.

### CROSS REFERENCE TO RELATED APPLICATION

This application is related to and claims priority from earlier filed provisional patent application Ser. No. 60/804,511, filed Jun. 12, 2006 and incorporated herein by reference.

### BACKGROUND OF THE INVENTION

The present invention generally relates to bird feeders, namely, tubular bird feeders. More specifically, the present invention relates to bird feeder bases and threaded bores for such tubular bird feeders.

In the bird feeder industry, tubular bird feeders are very well known. These feeders include a tubular main feed body which is commonly transparent or translucent so the amount of feed remaining therein can be easily seen. Feed ports in the tubular body permit birds to gain access to the feed therein. A tubular bird feeder also typically includes a number of perches routed through or attached to the tubular body to support a bird during feeding through one of the feed ports.

A tubular bird feeder typically has an open top and bottom open end. The top open end is covered by a removable cap so feed may be introduced into the tubular body. Bails are also provided so the feeder can be hung from a support. The bottom of the main tubular body is also closed, typically permanently, by a bottom base or cap. This base is usually screwed on or riveted to the bottom of the tubular main body to keep it closed.

The bases of bird feeders are commonly provided with a female threaded bore of the bottom thereof to receive various accessories, such as a male threaded post so that the feeder can be post mounted or a seed tray.

A bird feeder base itself is typically formed by die casting, or the like to form a unitary base structure. For example, a bird feeder base can be cast out of metal or molded out of plastic. To provide the female threaded bore to receive accessories, such as a post mount, the threaded bore is drilled and tapped in a secondary operation to provide a full helical thread to provide the necessary threading to receive a male threaded post, and the like. This takes additional time and effort in addition to the manufacturing step of forming the base itself. As a result, added cost is required to provide a female threaded bore with prior art known bird feeder bases. Higher quality plastic can also be drilled and tapped in this secondary operation. However, it has been found that lower quality plastics are not suitable at all for drilling and tapping. Thus, bird feeder bases cannot be easily formed of low quality plastics when a female threaded bore is desired.

In this prior art example, the base can be formed by machining or casting out of metal. A number of threads, i.e. one continuous helical thread that is routed more than 360 degrees, are provided on the inner surface of the bore.

A threaded post mount, the form of a bore, can be provided in the bottom of the base. As is known, the post is inserted into the ground so the feeder can be positioned above the ground. A squirrel guard, for example, may also be included as an additional accessory to assist in protecting the feeder from unwanted animals. For this configuration, the male threading on the post is threadably engaged with the female threading of a full helical thread on the base.

Therefore, there is a need for an improved bird feeder base that provides the necessary female threaded bore on the bottom thereof but does not require the laborious and costly drilling and tapping to provide such a threaded bore.

### SUMMARY OF THE INVENTION

An embodiment of the present invention preserves the advantages of prior art bird feeder bases. In addition, it provides new advantages not found in currently bird feeder bases and overcomes many disadvantages of such currently available bird feeder bases.

The embodiment is generally directed to a novel and unique bird feeder base. A bird feeder base contains a main body having a bore therein that has an inner surface. The inner surface of the bore is provided with at least one female thread member residing and extending less than 360 degrees about such inner surface. In a preferred embodiment, the bore has an inner surface with one female thread. The bore and thread member on the inner surface thereof is threadably engagable with a male threaded accessory, such as a mounting post.

It is therefore an object of the embodiment to provide a bird feeder base defining a bore with an inner surface that has at least one thread member residing and extending less than 360 degrees about such inner surface.

It is a further object of the embodiment to provide a bird feeder base having a thread member that completely obviates the need for expensive and time consuming drilling and tapping to form a thread member to receive male threading accessories, such as mounting posts.

Another object of the embodiment is to provide a bird feeder base that much less expensive and easier to manufacture than prior art bases.

Other objects, features and advantages of the invention shall become apparent as the description thereof proceeds when considered in connection with the accompanying illustrative drawings.

### BRIEF DESCRIPTION OF THE DRAWINGS

The novel features which are characteristic of the dispensing closure are set forth in the appended claims. However, the dispensing closure, together with further embodiments and attendant advantages, will be best understood by reference to the following detailed description taken in connection with the accompanying drawings in which:

FIG. 1 is a perspective view of a prior art bird feeder mounted on a bird feeder post;

FIG. 2 is a perspective view of a prior art bird feeder base;

FIG. 3 is a side view of a bird feeder with a prior art bird feeder base mounted on a post;

FIG. 4 is a side view of a bird feeder with a prior art bird feeder base with a seed tray;

FIG. 5 is a top perspective view of the bird feeder base in accordance with the present invention;

FIG. 6 is a bottom view of the bird feeder base of FIG. 6;

FIG. 7 is a top view of the bird feeder base of FIG. 6;

FIG. 8 is a cross-sectional view of the bird feeder base with mounting post installed therein;

FIG. 9 is a side view of two die molds joined to form a single female thread within the bird feeder base in FIG. 5A; and

FIG. 10 is a side view of one mold of FIG. 8A showing the shut-off surface therein to form the thread of the present invention.

### DETAILED DESCRIPTION OF THE PREFERRED EMBODIMENTS

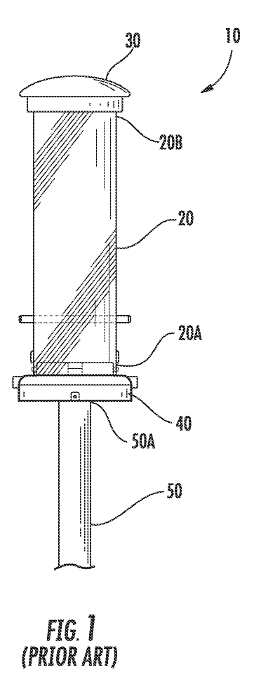

As shown in FIGS. 1-4, a bird feeder 10 known in the prior art is shown. The bird feeder 10 of the prior art is merely used to recite non-essential elements of the present invention. Referring to FIG. 1, a perspective view of a prior art bird feeder 10 is provided. The bird feeder 10 includes a tube 20 for storage of bird food with a bottom open end 20a and a top open end 20b; a cover 30 removably attached to the top open end 20b of the tube 20 for protecting bird food; a bird feeder base 40 used for sealing a bottom open end 20a of the tube 20; and a mounting post 50 threadably attached to the bird feeder base 40.

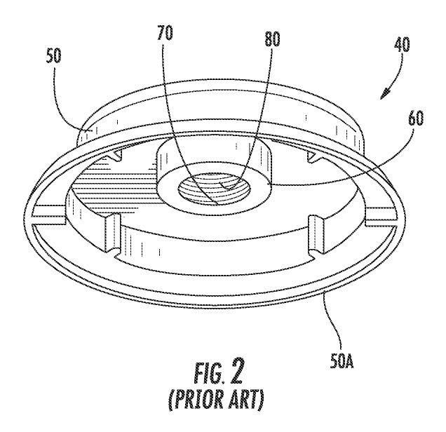

Referring now to FIG. 2, a perspective view of a prior art bird feeder base 40 from FIG. 1 is shown. The bird feeder base 40 has a main body 50 with a bottom edge 50a defining a bore 60 with an inner surface 70. A helical thread member 80 resides on the inner surface 70 of the bore 60 which is a female thread member 80 extending inwardly towards a center of the bore 60. The female thread member 80 is continuous for more than 360 degrees of the inner surface 70 of the bore 60.

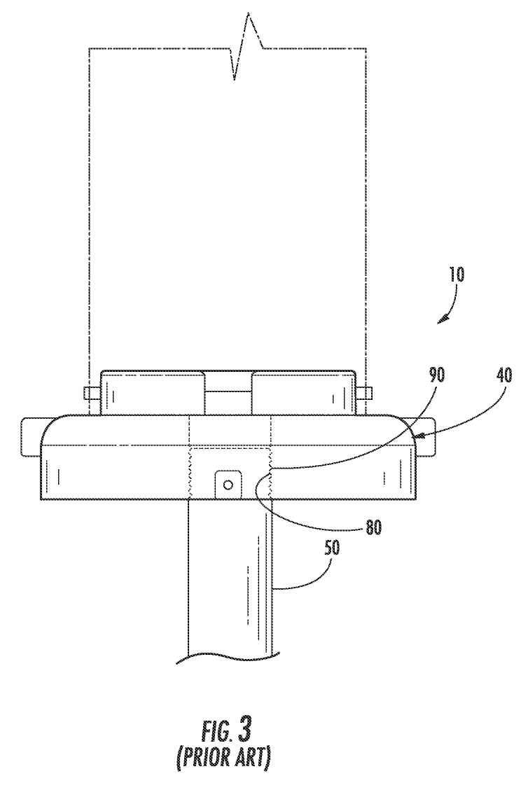

The inner surface 70 of the bore 60 is designed for threadable engagement with a variety of male threaded accessories. In FIG. 3, a side view of the bird feeder 10, with a bird feeder base 40 threadably engaged to a mounting post 50, is provided. The male threaded mounting post 50 has continuous male threads 90 which are threadably engageable with the threads of continuous female thread member 80.

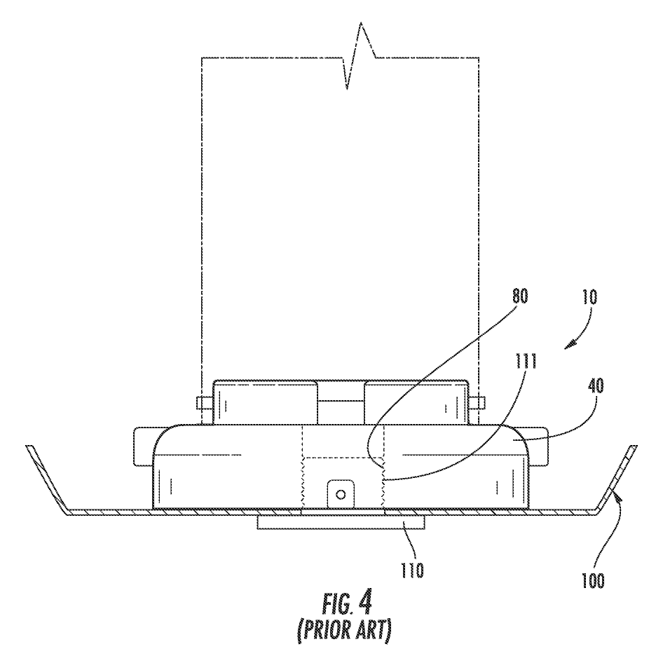

Referring to FIG. 4, another male threaded accessory for attachment to the bird feeder 10 is a seed tray 100. The seed tray 100 is threadably attached to the bird feeder base 40 by providing a male threaded plug 110 with having a post with a continuous male thread member 111 which is threadably engageable with the threads of continuous female thread member 80. The plug 110, in another embodiment, may be substituted for a male threaded mounting post 50 as described herein for securing the seed tray 100 to the bird feeder base 40.

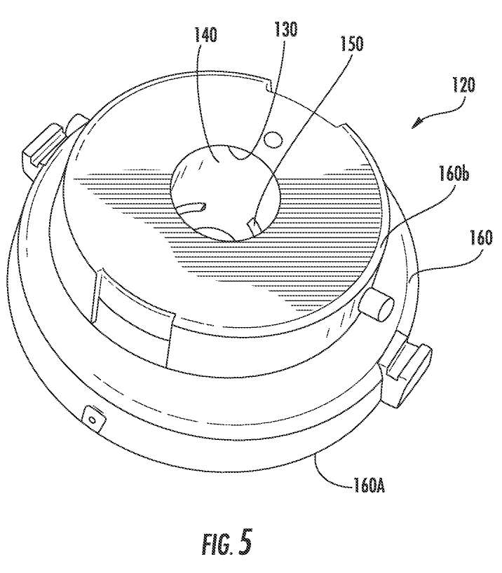

As shown in attached FIGS. 5-7, a bird feeder base 120 of the present invention is shown that provides a solution to prior art bird feeder base 40 disclosed in FIGS. 1-4.

FIG. 5 shows a perspective view of the base of the present invention. The bird feeder base 120 has a main body 160 with a bottom edge 160A defining a bore 130 with aperture 132 therethrough with an inner surface 140. The inner surface 140 contains at least one female thread member 150 extending inwardly towards a center of the bore 130. The female thread member 150 is preferably continuous for less than 360 degrees of the inner surface 140 of the bore 130.

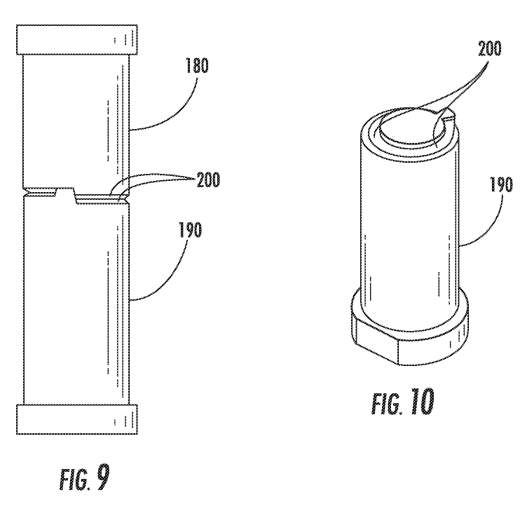

In contrast to prior art bird feeder base 40, the threaded bore 130 is manufactured without requiring the steps of drilling and tapping to form the female thread member 150 on the inner surface 140 thereof. By reducing the additional steps of drilling and tapping of the threaded bore 130, the present invention provides a more cost-effective bird feeder base 120. Instead, the base 120 and its thread 150 is formed preferably using die molds, as in FIGS. 9 and 10 rather than formed by drilling and tapping. This process will be described later in connection with FIGS. 9 and 10.

The bird feeder base 120 of the present invention can be cast out of metal to form the main body 160 as well as the integrated female thread member 150. Also, the bird feeder base 120 of the present invention can be molded out of plastic, such as by injection molding, to form the main body 160 as well as the integrated female thread member 150. Other materials and formation techniques may be used and still be within the scope of the present invention.

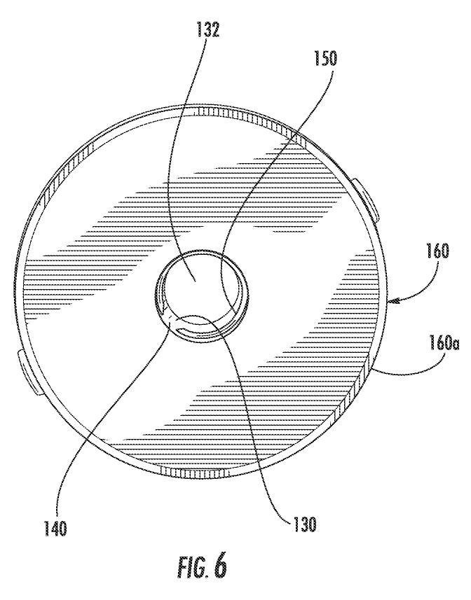

Referring to FIG. 6, a bottom view of the bird feeder base 120 of the present invention is shown in detail. The main body 160 contains a bottom edge 160a, which is similar to the bottom edge 50a, as seen in FIG. 2. The bottom edge 160a defines a bore 130 which has an inner surface 140 with at least one thread member 150, as seen in FIG. 5B. Unlike the prior art thread member 80, the female thread member 150 is continuous for less than 360 degrees of the inner surface 140 of the bore 130. Preferably, the inner surface 140 has one female thread member 150 which is substantially helical in configuration to be compatible with standard male threads that are found on typical bird feeder accessories.

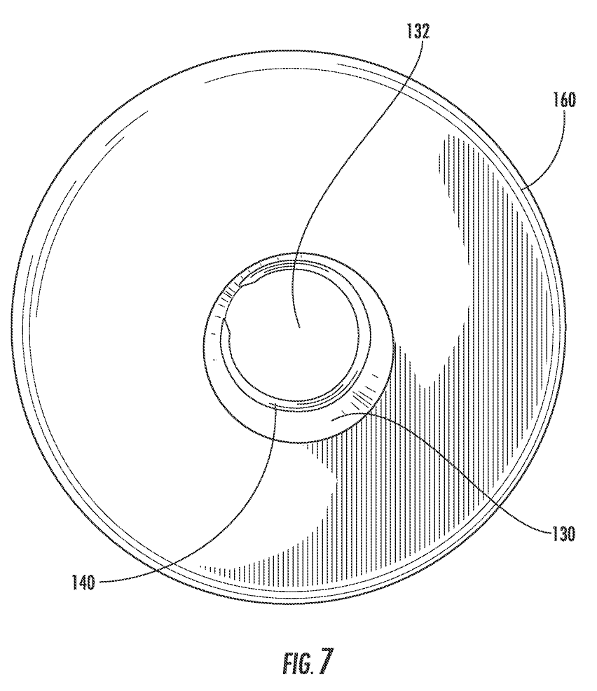

Referring to FIG. 7, a top view of the base is shown. It can be seen that female thread member 150 is positioned near the bottom of the bore 130 which provides sufficient lateral support to the shaft of a male threaded accessories threadably engaged therein. For example, when a male threaded mounting post 180, described further below, is threadably secured to single female thread member 150 and residing in the bore 130 and extending into the upper portion of the bore 130, it is sufficiently prevented from moving side to side within the bore 130. Thus, only one thread is needed to effectively secure and stabilize a mounting accessory within the base.

Referring back to FIG. 5, it should be understood that the main body 160 has a top surface 160b designed for attachment to a bird feeder tube 20 at its lower open end 20a, as seen in FIG. 1. Any available means, known in the art, is suitable for attachment of the base to the tube 20 can be employed. For example, the base 120, like any prior art base, can be attached using rivets, spring-loaded mechanisms, glue, screws, and the like.

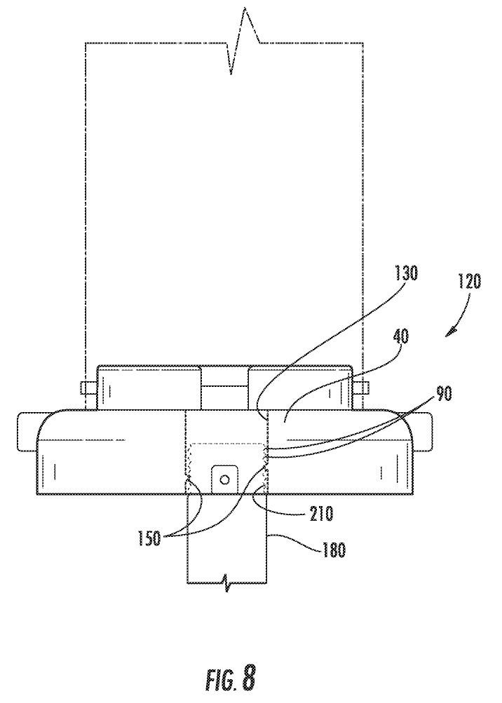

The inner surface 140 of the bore 130 is designed for threadable engagement with a variety of male threaded accessories, such as a mounting post 180. In FIG. 8, a cross-sectional view of the bird feeder base 120 threadably attached to a mounting post 180, by way of example, is shown. The male threaded mounting post 180 has male threads 90, as also seen in FIG. 3, which are threadably engageable with the female thread member 150 in bore 130. As can be seen in this cross-sectional view, only one thread 150 engages with the post 180. This is all that is needed to secure the post 180 because the uppermost portion of the post is captured by the upper portion of the bore 130 that does not have threads. As stated above, this configuration effectively secures the post 180 in place thereby preventing it from moving back and forth within the bore 130. In addition, other male threaded accessories, such as a squirrel guard (not shown) can be threadably attached to the bird feeder base 120 of FIGS. 5-8.

The male threaded mounting post 180, with or without a squirrel guard, is essentially the same for threadable attachment with the bird feeder base 120 of the present invention or with the bird feeder base 40 in the prior art. However, the bird feeder base 120 of the present invention has the female thread member 150 which is continuous for less than 360 degrees of the inner surface 140 of the bore 130. As a result, the bird feeder base 120 of the present invention is much less expensive and easier to manufacture than the prior art base 40.

Referring now to FIGS. 9 and 10, the female thread member 150 is formed by providing two mating casting die halves 180,190. The casting dies 180,190 include shut-off surfaces 200 that mate together to define the female thread member 150 on the inner surface 140 of the bore 130. Preferably, the female thread member 150 is a single protrusion extending inwardly on the inner surface 140 of the bore 130 for less than 360 degrees. By extending the female thread member less than 360 degrees on the inner surface 140, it allows the threading to be formed by two mating die/casting halves 180,190 without using collapsible cores or moving die parts. Thus, in accordance with the present invention, two static casting die halves 180,190 are used to form the integrally formed female thread member 150 extending less than 360 degrees by molding which is a less expensive and easier process than drilling and tapping to form a female threaded bore.

It should be noted that the dies 180, 190 are used to form the thread 150 of the present invention. Additional molds (not shown) are used to form the remainder of the base member, in accordance with the present invention. FIG. 5 shows the base as a unitary body molded from a single mold using the dies 180, 190, as above. As seen in FIGS. 6 and 7, is also possible to form the base from a number of different parts to streamline the manufacturing process. For example, an outer base shell can be provided to receive a bottom floor. Any construction is envision as being part of the present invention. Most importantly, the central bore include the single thread 150 of the present invention.

In view of the foregoing, a new and novel improved bird feeder base 120 is provided. It uniquely includes the female thread member 150 that is integrally formed with the main body 160 itself and is contained within the inner surface 140 of the bore 130 for less than 360 degrees. This completely obviates the need for expensive and time consuming drilling and tapping to form the female thread member 150 to receive male threading accessories, such as a mounting post 180 or squirrel guard.

Therefore, while there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A bird feeder base, comprising:
a main body defining a bore therein having an inner surface;
at least one female thread member residing on the inner surface of the bore and extending less than 360 degrees about such inner surface;
whereby a male threaded accessory is threadably engageable with the bore and female thread member on the inner surface thereof.

2. The bird feeder base of claim 1, wherein the thread member is substantially helical.

3. The bird feeder base of claim 1, wherein the male threaded accessory is a mounting post.

4. The bird feeder base of claim 1, wherein the male threaded accessory is a squirrel guard.

5. The bird feeder base of claim 4, wherein the male threaded accessory is a mounting post with a squirrel guard.

6. The bird feeder base of claim 1, wherein the male threaded accessory is a seed tray.

7. The bird feeder base of claim 6, wherein the male threaded accessory is a mounting post with a seed tray.

8. A bird feeder, comprising:
a tube for storage of bird food;
a bird feeder base attached to a bottom open end of the tube to prevent the food from exiting the tube;
the bird feeder base having a main body with a bottom edge; the bottom edge defining a bore having an inner surface;
at least one female thread member residing on the inner surface of the bore and extending less than 360 degrees about such inner surface;
a mounting post having male threads for attachment to the bird feeder base;
whereby the male threaded is threadably engageable with the bore and female thread member on the inner surface thereof.
